(19) United States
(12) Patent Application Publication
(10) Pub. No.: US 2025/0104460 A1
(43) Pub. Date: Mar. 27, 2025

(54) HIGH ACCURACY DOCUMENT SOURCE DETECTION

(71) Applicant: EchoMark, Inc., Kirkland, WA (US)

(72) Inventors: Sanjay KRISHNAN, Hinsdale, IL (US); David WONG, Los Gatos, CA (US); Chad VOSS, Seattle, WA (US); Troy BATTERBERRY, Kirkland, WA (US)

(21) Appl. No.: 18/592,118

(22) Filed: Feb. 29, 2024

Related U.S. Application Data
(60) Provisional application No. 63/585,558, filed on Sep. 26, 2023.

(51) Int. Cl. G06V 30/418; G06V 30/414

(52) U.S. Cl. CPC G06V 30/418; G06V 30/414

(57) ABSTRACT

A document source is determined with high accuracy. Unique copies of an original document can be created. To determine which of the unique copies matches an artifact, keypoints of the unique copies and the artifact are identified. The unique copy keypoints are matched to the artifact keypoints. The unique copies are ranked based on the number of matching keypoints. An absolute match significance is determined from an absolute match fraction, comprising the number of matching unique copy keypoints for each unique copy relative to the total unique copy keypoints. A unique match significance is determined from a unique match fraction, comprising the number of uniquely matching keypoints for each unique copy relative to the total unique copy keypoints. The identification of the unique copy as matching the artifact is determined based on the absolute match significance and the unique match significance.

### CROSS-REFERENCE TO RELATED APPLICATIONS

This Application claims the benefit of priority to U.S. Provisional Application No. 63/585,558, filed Sep. 26, 2023, and entitled “High Accuracy Document Source Detection,” the contents of which are hereby incorporated by reference in their entirety.

### BACKGROUND

In document security and management, the ability to identify the source of a document is helpful to dissuade data leaks and identify potential sources of leaks, should one occur. Various methods have been employed to trace document origins, including the use of watermarks, digital signatures, and metadata. Unique markings, such as specialized fonts or distinct spacing patterns offer an additional avenue for embedding information within the document for source identification. Document source detection generally involves two elements: an encoding process that encodes documents with information, and a decoding process that uses the encoded information to identify the document source.

### SUMMARY

The technology generally relates to determining document sources using high-accuracy determination measures that apply matching keypoints between an artifact and unique copies from a set of unique copies. Methods described herein provide a high level of confidence when identifying and detecting document sources, and may be used to discourage leaks and identify a leaked document source, should a leak occur.

To do so, unique copies of an original document are generated with perturbations that distinguish the unique copies. The unique copies are part of a set of unique copies. To identify a unique copy from the set that matches the artifact, keypoints are identified for locations in the unique copies and in the artifact, respectively called unique copy keypoints and artifact keypoints. The unique copy keypoints are matched to the artifact keypoints based on their respective locations in the documents.

The keypoints can be used to rank the set of unique copies. Those unique copies having a higher relative number of matching keypoints can be ranked higher. For instance, an absolute match fraction can be determined for each of the unique copies, which may include a number of unique copy keypoints that match artifact keypoints relative to the total number of unique copy keypoints for an individual unique copy. The ranking may be based on the absolute match fraction, and may include at least a first-ranked unique copy and a second-ranked unique copy.

Further, uniquely matching keypoints for each unique copy may be determined. The uniquely matching keypoints can include unique copy keypoints that match artifact keypoints, and where the matching artifact keypoints do not match other unique copy keypoints from other unique copies in the set.

The matching unique copy can be determined using an absolute match significance and a unique match significance. The absolute match significance may be determined from the absolute match fractions of the first-ranked unique copy and the second-ranked unique copy, and may identify whether the absolute match fraction of the first-ranked unique copy is statistically significant. The unique match significance may be determined from the unique match fractions of the first-ranked unique copy and the second-ranked unique copy, and may identify whether the unique match fraction of the first-ranked unique copy is statistically significant. Based on identifying that both the absolute match significance and the unique match significance are significant, the first-ranked unique copy may be identified as the unique copy from which the artifact was derived. In aspects, the absolute match significance and the unique match significance are combined to get an overall probability to determine whether the artifact was derived from the unique copy.

This summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an example operating environment in which aspects of the technology can be employed, in accordance with an aspect described herein;

FIG. 2 illustrates an example set of unique copies generated from an original document and artifacts derived therefrom, in accordance with an aspect described herein;

FIG. 3 illustrates an example process for identifying and determining a unique copy from which an artifact was derived;

FIG. 4A illustrates an example unique copy, in accordance with an aspect described herein;

FIG. 4B illustrates the unique copy of FIG. 4 having example unique copy keypoints, in accordance with an aspect described herein;

FIG. 5A illustrates an example artifact derived from the unique copy of FIG. 4A, in accordance with an aspect described herein;

FIG. 5B illustrates the example artifact of FIG. 5A having example artifact keypoints, in accordance with an aspect described herein;

FIG. 6 is an illustrative matching of the unique copy keypoints of FIG. 4B with the artifact keypoints of FIG. 5B, in accordance with an aspect described herein;

FIG. 7 illustrates an overlay of the unique copy of FIG. 4B with the artifact of FIG. 5B based on the matching shown in FIG. 6, in accordance with an aspect described herein;

FIG. 8 illustrates an example use of an absolute match significance determiner included in FIG. 1, in accordance with an aspect described herein;

FIG. 9 illustrates an example use of a unique match significance determiner included in FIG. 1, in accordance with an aspect described herein;

FIG. 10 illustrates an example method for determining that an artifact was derived from a unique copy using identified keypoints, in accordance with an aspect described herein; and

FIG. 11 illustrates an example computing device in which aspects of the technology may be employed, in accordance with an aspect described herein.

### DETAILED DESCRIPTION

Consider a scenario where there exists a set of unique copies of a particular document, where each unique copy is a uniquely marked copy of an original document. When an artifact (derived from a unique copy of the document) is discovered, the objective is to trace it back to the unique copy from which it was derived. Traditional methods may employ various algorithms to find the copy that matches the artifact. However, some of the conventional approaches that rely on matching the artifact to a unique copy have inherent limitations.

In some cases, the dataset containing the unique copies is not exhaustive. There may be additional unique copies not included in the dataset. For instance, an incomplete dataset may be the result of an incomplete document search process, e.g., with e-discovery tools. Existing methods that attempt to identify the unique copy from the artifact by matching might identify an incorrect unique copy if the dataset excludes the actual matching unique copy. That is because the matching algorithms of these methods pick the best matching unique copy, and may do so among a dataset that does not include the correct match. Said differently, with these existing methods, even if one of the unique copies in the set partially matches the artifact, it does not necessarily mean the artifact was derived from that particular copy, particularly when the artifact was not derived from any of the unique copies in the dataset. Such issues could lead to identifying incorrect results. Without a reliable error metric to quantify the selection measure, it is challenging to identify a matching unique copy by assessing the likelihood that the artifact was indeed derived from the unique copy.

Further still, without methods that identify unique copies using error quantification metrics, it is difficult to evaluate the robustness of the source detection in the presence of noise, modifications, or other distortions in the artifact. Noise and distortions can alter the features that the detection algorithms rely upon, reducing the likelihood of a correct match. For example, a change in wording can disrupt text pattern recognition algorithms. The presence of noise such as this leads conventional methods to output false positives where the algorithm incorrectly identifies a unique copy as the source. This is especially problematic when the noise randomly aligns the artifact with features of a unique copy it was not derived from. Conversely, noise can also lead to false negatives, where the algorithm fails to identify the correct unique copy even when it is present in the dataset. In all, noise adds another layer of complexity to the already difficult task of quantifying error in source detection.

Traditional methods often lack the sophistication to account for noise in their error metrics, sometimes leading to poor performance when determining the unique copy from which an artifact was derived. For example, traditional methods might not have built-in mechanisms to weigh the significance of different types of noise or to differentiate between minor distortions and major alterations. These methods often do not provide a quantifiable measure of confidence or error rate, making it difficult to assess the reliability of the output source detection. As a result, traditional algorithms are ill-equipped to handle the complexities introduced by noise and distortions, leading to less reliable and less actionable outcomes.

The technology disclosed herein provides advances over some of the existing methods. For instance, embodiments of the present disclosure provide for superior alignment techniques using certain identifiable points on each of a discovered artifact and the unique copies, referred to respectively as artifact keypoints and unique copy keypoints. These can be aligned and matched, and in doing so, provide a basis for a quantifiable metric that can be used to reduce false negative selection and to confidently identify the unique copy from which the artifact was derived. Moreover, the keypoint-based metric reduces false positives by indicating that none of the unique copies of the set could confidently be matched according to a statistically significant event.

To achieve these benefits, and to more confidently match unique copies to artifacts, one example process includes identifying unique copy keypoints in the unique copies and identifying artifact keypoints in the artifact. The unique copy keypoints are matched to the artifact keypoints for each unique copy.

For each unique copy, an absolute match fraction and a unique match fraction are determined. The absolute match fraction may be a fraction of unique copy keypoints that match artifact keypoints to the total unique copy keypoints for an individual unique copy. The unique match fraction may be a fraction of uniquely matching keypoints to the total unique copy keypoints for an individual unique copy. The uniquely matching keypoints for a unique copy may be those unique copy keypoints that match artifact keypoints, where the matching artifact keypoints do not match other unique copy keypoints from other unique copies in the set.

The unique copies may be ranked based on the uniquely matching keypoints. Unique copies having a relatively greater number of unique copy keypoints matching artifact keypoints are ranked higher. The ranking may include at least a first-ranked unique copy and a second-ranked unique copy as the two highest ranked unique copies.

An absolute match significance and a unique match significance can be determined for at least the first-ranked unique copy. The absolute match significance may be determined from the absolute match fractions of at least the first-ranked unique copy and the second-ranked unique copy, and may identify whether the absolute match fraction of the first-ranked unique copy is statistically significant. The unique match significance may be determined from at least the unique match fractions of the first-ranked unique copy and the second-ranked unique copy, and may identify whether the unique match fraction of the first-ranked unique copy is statistically significant. Based on identifying that both the absolute match significance and the unique match significance are significant, the first-ranked unique copy may be identified as the unique copy from which the artifact was derived.

In aspects, the absolute match significance and the unique match significance are combined to get an overall probability. The overall probability may be compared to a threshold value determined through empirical offline testing to determine whether the artifact was derived from the unique copy.

As such, the process may involve two failure modes—a first event using the absolute match significance that determines the likelihood that an artifact was derived from a unique copy relative to other unique copies in the set, and a second event using the unique match significance that determines the likelihood that the artifact was derived from the unique copy relative to documents outside of the set.

The combination of these two metrics provides a high degree of accuracy when determining whether an artifact was derived from a unique copy. This helps avoid two outcomes that some existing methods fall short on-one, a random chance event that the artifact was derived from another unique copy of the set, and two, that the determined unique copy was the best selection of all poorly matched unique documents in the set. Either event can serve as a type of stopgap when determining if a candidate unique copy match is the unique copy from which the artifact was derived. The probability of the events, i.e., the unique match significance and the absolute match significance, may be combined in aspects to determine the overall probability that the artifact was derived from the unique copy. This can be compared to an empirically determined threshold for a high-confidence determination that the artifact was derived from the unique copy.

It will be realized that the method previously described is only an example that can be practiced from the description that follows, and it is provided to more easily understand the technology and recognize its benefits. Additional examples are now described with reference to the figures.

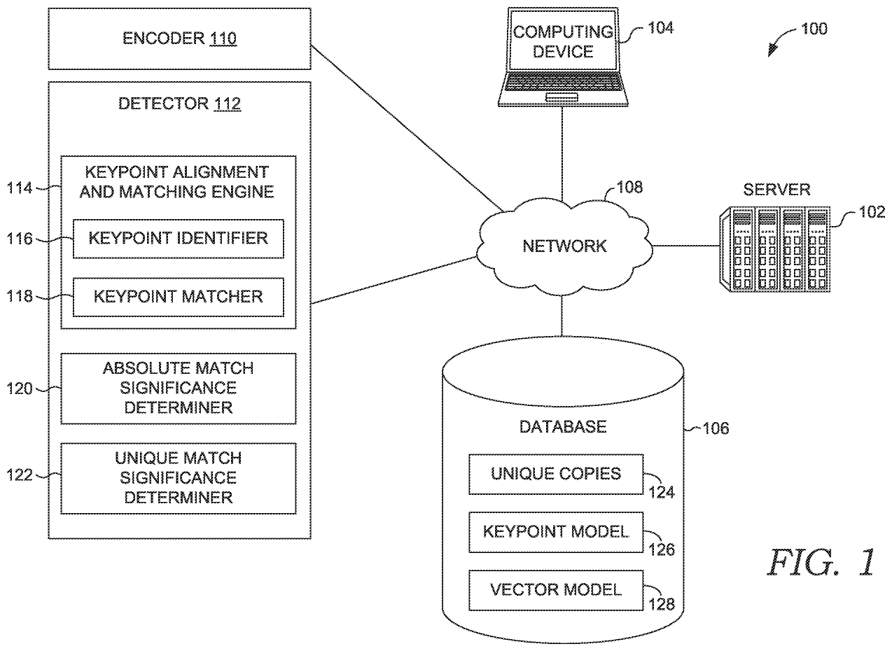

With reference now to FIG. 1, an example operating environment 100 in which aspects of the technology may be employed is provided. Among other components or engines not shown, operating environment 100 comprises server 102, computing device 104, and database 106, which are communicating via network 108, each in communication via network 108 to encoder 110 and detector 112.

Database 106 generally stores information, including data, computer instructions (e.g., software program instructions, routines, or services), or models used in embodiments of the described technologies. Although depicted as a single database component, database 106 may be embodied as one or more databases or may be in the cloud. In aspects, database 106 is representative of a distributed ledger network.

Network 108 may include one or more networks (e.g., public network or virtual private network [VPN]), as shown with network 108. Network 108 may include, without limitation, one or more local area networks (LANs), wide area networks (WANs), or any other communication network or method.

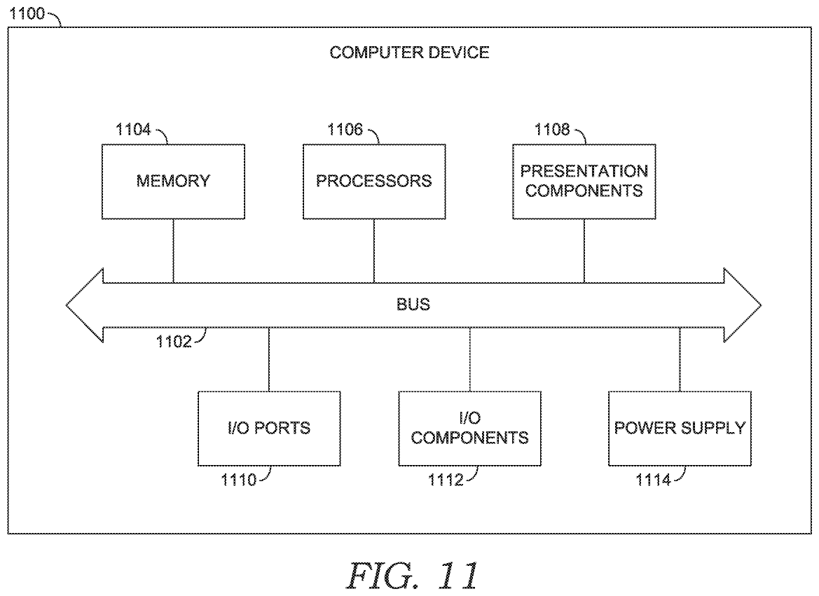

Generally, server 102 is a computing device that implements functional aspects of operating environment 100, such as one or more functions of detector 112, to determine a unique copy from which an artifact was derived with high accuracy. In an embodiment, server 102 performs functions of encoder 110 to generate unique copies by encoding each unique copy with perturbations made to an original document. One suitable example of a computing device that can be employed as server 102 is described as computing device 1100 with respect to FIG. 11. In implementations, server 102 represents a back-end or server-side device.

Computing device 104 is generally a computing device that may be used to provide an artifact for determining a unique copy from which it was derived, among other possible functions. As with other components of FIG. 1, computing device 104 is intended to represent one or more computing devices. One suitable example of a computing device that can be employed as computing device 104 is described as computing device 1100 with respect to FIG. 11. In implementations, computing device 104 is a client-side or front-end device. In addition to server 102, computing device 104 may implement functional aspects of operating environment 100, such as one or more functions of 112. It will be understood that some implementations of the technology will comprise either a client-side or front-end computing device, a back-end or server-side computing device, or both, executing any combination of functions from 112, among other functions.

As noted, the technology is suitable for generating unique copies of an original document and identifying a unique copy from which an artifact was derived. Encoder 110 and detector 112 may be employed to perform this functionality. In general, encoder 110 encodes unique information within copies of an original document by making one or more perturbations between the original document and each unique copy. Detector 112 generally identifies a unique copy from which an artifact of the unique copy is derived.

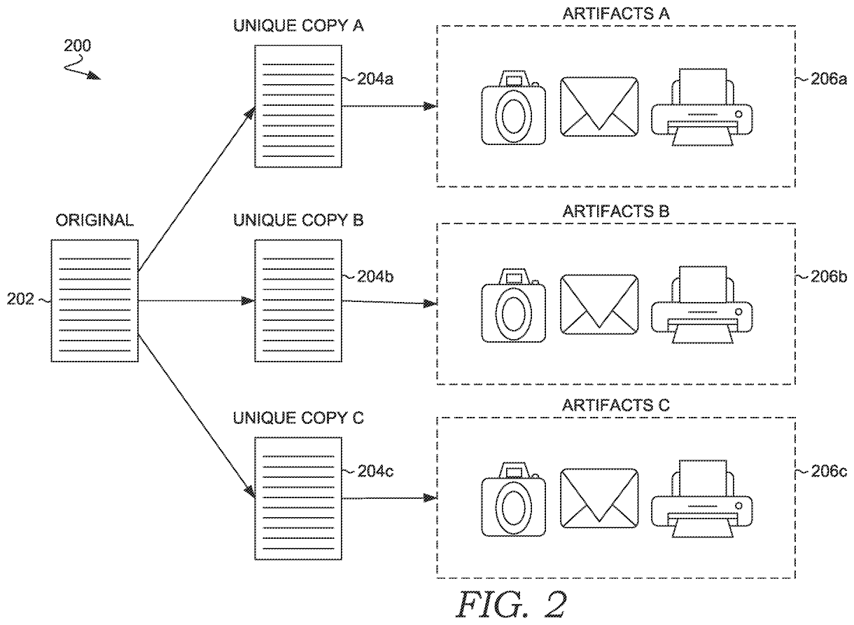

FIG. 2 provides illustration 200 that depicts an example set of unique copies generated using encoder 110 and artifacts derived from these unique copies. FIG. 2 illustrates original document 202. Generally, an original document, such as original document 202, may be any document type that conveys content therein, such as text, images, tables, graphs, and so forth. For example, documents, including original documents, unique copies, artifacts, and so forth, can include various file types, such as JPEG (Joint Photographic Experts Group), GIF (graphics interchange format), SVG (scalable vector graphics), PNG (portable network graphic), BMP (bitmap), TIFF (tagged image file format), PDF (portable document format), Word document (e.g., DOC, DOCX), HTML (hypertext markup language), spreadsheets (e.g., XLS or XLSX), text files (e.g., TXT, WPD), PowerPoint (e.g., PPT, PPTX), ODP (open document presentation), KEY (Keynote file), message file (MSG), and email (EML), among other document types.

Unique copies, such as unique copies 204a-204c, are copies of an original document, such as original document 202, in which encoder 110 has made a perturbation. Unique copies are unique in that one unique copy has at least one different perturbation between the original and the unique copy relative to another unique copy. In this way, there is a distinctive feature for each of the unique copies. Encoder 110 may mark each of the unique copies with one or more perturbations, giving them a distinctive watermarking that can be used to individually distinguish each unique copy. These perturbations may be applied in a manner that is challenging to detect with the human eye, but can be identified by a computing device to identify the unique copy from the others.

As an example, one or more perturbations, i.e., changes, made by encoder 110 to an original document to generate a unique copy, may include changes in spacing, such as adding or removing spaces. Spaces between content, such as text characters, may be changed by increasing or decreasing the number of pixels of the space between the content. In implementations, this may be done in a net-zero manner. That is, pixel spaces within vertical or horizontal lines of content can be added and removed so that there is no net change over the entire line of the document, making the unique copy resemble the original document. For example, a pixel of space may be added between content along a line of the document, while another pixel of space is removed from the same line, making the unique copy appear similar to the original document when viewed with the human eye. Another example perturbation includes font changes. For instance, fonts similar to the font used can be changed for one or more characters. Other perturbations may include general changes to the content, such as adding, removing, lengthening, or shortening parts of characters, such as an ear on the text of some fonts. Any number of perturbations can be made when generating a unique copy. Various changes may be made throughout a document when generating a unique copy so that individual fragments of the unique copy can be used to positively identify the unique copy.

Unique copies, such as unique copies 204a-204c, can be distributed to individual recipients. Thus, each recipient receives a unique copy of the original document that is unique to the recipient. Unique copies may be provided in any manner, such as a printed document, an email attachment, a message body, or other like delivery method. A mapping (e.g., a data index) can be kept to indicate an association between a unique copy and a recipient, thus allowing identification of the recipient via the mapping when the unique copy is known, e.g., has been identified from an artifact. Having generated unique copies using encoder 110, the unique copies may be stored in database 106 as unique copies 124 for use by other components of operating environment 100. As noted, a mapping that identifies recipients may also be stored in database 106.

Some example artifacts are also illustrated in FIG. 2 as artifacts 206a-206c. In general, artifacts are derivations of a unique copy. As illustrated in FIG. 2, artifacts A 206a have been derived from unique copy A 204a, artifacts B 206b have been derived from unique copy B 204b, and artifacts C 206c have been derived from unique copy C 204c.

In general, an artifact, such as those illustrated, can be any derivation, in whole or in part, from a unique copy. For instance, an artifact may be a whole document of the same file type. For example, this may occur if a unique copy is attached to an email or included in the body of an email that is then forwarded to another recipient. An artifact may be a fragment of a unique copy that is the same file type. As an example, if a portion of a PDF document is provided to someone other than the initial recipient as a PDF, the portion provided is an artifact of the unique copy. In another example, the artifact may be a whole or partial replication of a unique copy that is in a different format. For instance, a photo, snip, or cut-and-paste of the unique copy can derive an artifact. Artifacts may be in the form of the computer-readable file formats, photos (including various angles), printed documents, copied and pasted content, email attachments, and other like derivations. Artifacts may include compound artifacts, such as those artifacts having multiple or combinations of derivations from the unique copy. These artifacts may include, for example, a photo of a printed version of a unique document, or a document that has been converted through various file formats.

In the event that an artifact is derived from a unique copy of a set of unique copies generated by encoder 110, detector 112 can be deployed to determine the unique copy from the set of unique copies from which the artifact was derived, and can do so with high accuracy and confidence.

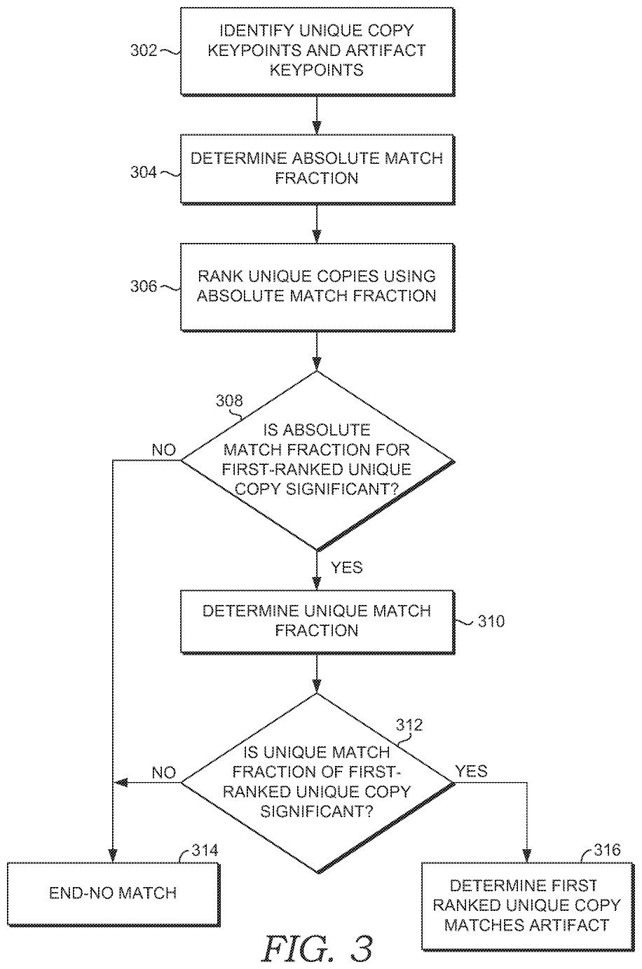

FIG. 3 illustrates an example process 300 that can be performed by detector 112 to match a unique copy to an artifact, i.e., determine the unique copy from which the artifact was derived. It is noted that this is only one example process, and it not intended to limit the technology to only this process. Other processes may be employed by detector 112 to match a unique copy to an artifact. To provide a select couple of examples, while FIG. 3 illustrates process 300 for determining absolute match fraction and making a decision based on the match fraction before proceeding to determine a unique match fraction and make a decision using it, it is also possible for these steps to be performed in the reverse order. It is also possible that these steps be performed in parallel. These steps may be performed by the same computing device or multiple computing devices, and may be done contemporaneously, in a sequence, or at different times, and in any suitable order. One of ordinary skill in the art will recognize this as only an example among other suitable alternatives.

To match an artifact to a unique copy, detector 112 may implement various functions. In the example illustrated by FIG. 1, detector 112 executes keypoint alignment and matching engine 114, absolute match significance determiner 120, and unique match significance determiner 122. In general, detector 112 identifies keypoints within the artifact and the unique copies. The identification of either artifact keypoints or unique copies may be done as a runtime process, or may be done offline and stored for use by components of operating environment 100. Based on the keypoints, a two-part decision-making process may be employed to accurately and confidently match the artifact to a unique copy. For instance, detector 112 may determine an absolute match significance using absolute match fractions determined for the unique copies from unique copy keypoints that match artifact keypoints in each individual unique copy. Detector 112 may also determine a unique match significance using unique match fractions determined from uniquely matching keypoints in each individual unique copy, where the uniquely matching keypoints are unique copy keypoints in an individual copy that match artifact keypoints, and the matching artifact keypoints do not match other unique copy keypoints in other unique copies. Using the absolute match significance and the unique match significance, detector 112 can determine with a high degree of accuracy the particular unique copy from which the artifact was derived. As noted, FIG. 3 illustrates one example among other suitable alternatives, which are intended to be within the scope of this disclosure.

Starting at block 302, unique copy keypoints and artifact keypoints are identified. In implementations, unique copy keypoints that match or uniquely match artifact keypoints can also be determined at this stage.

To match artifact keypoints of an artifact to unique copy keypoints of the unique copies of a set, such as unique copies 124, detector 112 of FIG. 1 can employ keypoint alignment and matching engine 114. Keypoint alignment and matching engine 114 further comprises keypoint identifier 116 and keypoint matcher 118, which can be employed to identify and match keypoints, and to align a unique copy to an artifact to more accurately identify matching keypoints. Keypoint alignment and matching engine 114 may perform an alignment between an artifact and one or more unique copies of a set of unique copies generated from an original document, such as unique copies 124. Keypoint identifier 116 generally identifies keypoints in the unique copies, referred to as unique copy keypoints, and also identifies keypoints in the artifact, referred to as artifact keypoints. Keypoints can be identified for any distinguishing feature within a document or artifact.

In some cases, keypoints may refer to an area of one or more pixels, e.g., a distinctive pixel pattern located at the distinguishing feature, including a pixel neighborhood, as will be further described. Features for which keypoints may be identified include content features that may be reproduced from the unique copy to the artifact. One such example uses corners created by content within the unique copy and the artifact. For example, corners may be created by text aligned at a margin, the location of a return in the text, spacing between text lines or characters, along a line across which text is generated, at edges of images, and at the edges of image borders, among other locations created by the content of the document.

To identify corners, keypoint model 126 can be trained and stored. Keypoint model 126 generally receives as an input a unique copy or an artifact, and respectively identifies unique copy keypoints or artifact keypoints. One example of keypoint model 126 comprises a neural network trained on a labeled dataset. One specific example is a convolutional neural network. The labeled dataset may include documents having labeled corners, such as any of those described. Keypoint model 126 identifies corners based on its training and is responsive to the input. One model that may be suitable for use is the Shi-Tomasi Corner Detector. This can be found at OpenCV, available at https://docs.opencv.org/3.4/d4/d8c/tutorial_py_shi_tomasi.html, the contents of which are incorporated by reference herein in their entirety. Having identified corners using keypoint model 126, the corners can be associated with keypoints, such as unique copy keypoints or artifact keypoints. In implementations, keypoint model 126 may identify upwards of 100,000 keypoints in a document. In some cases, the number of keypoints may be as low as 1,000 or less. In general, the larger the document and the more content included within the document, keypoint model 126 will identify a greater number of keypoints. While corners are one example feature that may be determined when identifying keypoints, other document features may be suitable for identifying keypoints. This is just one example suitable for use with the disclosed technology.

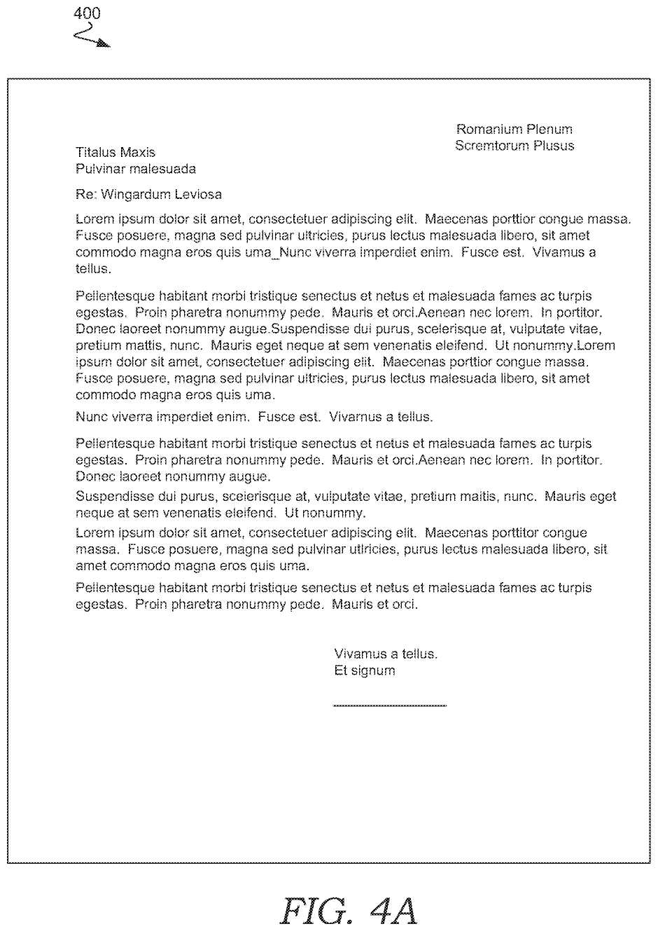

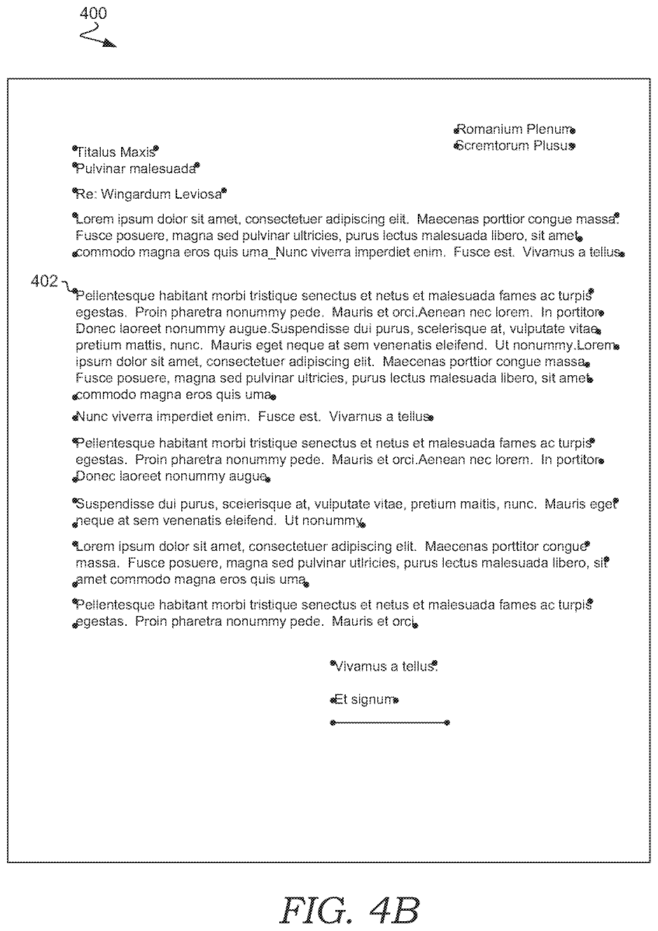

FIG. 4A illustrates an example unique copy 400 of an original document, on which keypoint alignment and matching engine 114 can be employed to identify unique copy keypoints for matching to artifact keypoints. Unique copy 400 includes perturbations throughout the content, which is text-based in this example. FIG. 4B illustrates an example of using keypoint identifier 116 to identify unique copy keypoints. Here, unique copy 400 of FIG. 4A is provided as an input to keypoint model 126. FIG. 4B illustrates some examples of keypoints identified by keypoint model 126 responsive to the input. It will be understood that this is only an example and that more or fewer keypoints across various locations of unique copy 400 may be identified. As illustrated in FIG. 4B, unique copy keypoint 402 is an example of one keypoint that is identified within unique copy 400.

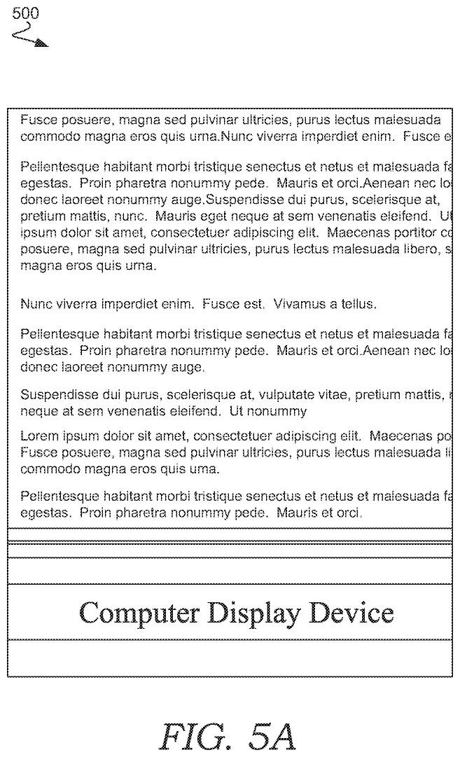

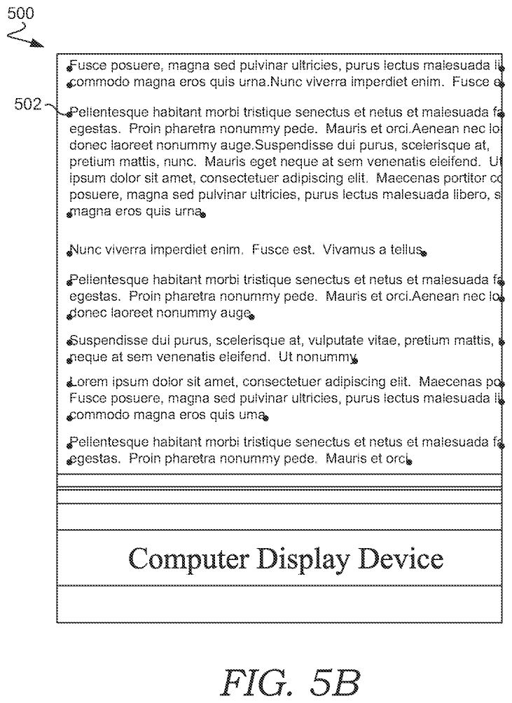

FIG. 5A and FIG. 5B similarly illustrate an example of using keypoint identifier 116 to identify artifact keypoints. Here, artifact 500 of FIG. 5A has been derived from unique copy 400. In this example, artifact 500 is a photo of unique copy 400 that was taken when unique copy 400 was displayed at a display device. Further, artifact 500 is a fragment of the unique copy 400, as it only includes a portion of the document. Artifact 500 of FIG. 5A can be provided as an input to keypoint model 126, which identifies artifact keypoints, as illustrated in FIG. 5B, responsive to the input. It will be understood that this is only an example and that more or fewer keypoints across various locations of artifact 500 may be identified. Artifact keypoint 502 is provided to illustrate one example artifact keypoint of those illustrated in FIG. 5B.

Using the identified keypoints, keypoint alignment and matching engine 114 may align a unique copy with an artifact. To align a unique copy with an artifact, keypoint alignment and matching engine 114 employ keypoint matcher 118 to match unique copy keypoints to artifact keypoints. In general, keypoint alignment and matching engine 114 match one or more of the unique copy keypoints to one or more corresponding artifact keypoints located in the artifact to determine the location in the unique copy from which the artifact was derived. Alignment helps adjust for the distortions that can be caused by perspective changes between the artifact and unique copy, allowing for a higher degree of comparison between the two when applying computer vision techniques relative to conventional methods that don't adjust for these offsets. It will be understood that, in some implementations of the technology, “alignment” is performed as a function of computer vision and comprises a determination or identification of which areas or pixels of the unique copy correspond to those of the artifact.

One example method that can be employed by keypoint matcher 118 to match keypoints uses pixel neighborhoods. Using this method, pixel neighborhoods are identified for the unique copy keypoints and the artifact keypoints. Pixel neighborhoods include an area that at least partially, or fully, surrounds a keypoint. For instance, pixels within a defined radius of a keypoint are within the pixel neighborhood of the keypoint. As an example, the radius defined for the pixel neighborhoods may be 5 pixels, 10 pixels, 15 pixels, 20 pixels, and so forth. It will be understood that the pixel neighborhood may be adjusted to any defined distance to tune the comparison between the pixel regions, which will be described in further detail.

Keypoint matcher 118 can employ vector model 128 to represent the pixels within the pixel neighborhoods as vectors in the vector space. That is, a feature of a pixel can be represented as a vector. While many pixel features may be used, such as color, one such feature that has been identified as suitable is the pixel intensity gradient, e.g., a representation of the intensity of one pixel relative to adjacent pixels. One such algorithm that is suitable as vector model 128 uses SIFT (scale-invariant feature transform). An example of this algorithm is provided by OpenCV and is available at https://docs.opencv.org/4.x/da/df5/tutorial_py_sift_intro.html, the contents of which are hereby incorporated by reference in their entirety. In general, keypoint model 126 can be used to look at pixel neighborhoods at various levels of blurring and compare features at the various levels. This vectorizes the pixel space around the keypoints.

By representing features of the pixel neighborhoods as vectors, the vectors representing pixels in pixel neighborhoods of unique copy keypoints can be compared to the vectors representing the pixels in pixel neighborhoods of the artifact. A Euclidean distance can be used to compare the vectors of the unique copy keypoint pixel neighborhoods to the artifact keypoint pixel neighborhoods. That is, the relatively closer the vectors of the unique copy keypoint pixel neighborhoods are to the vectors of the artifact keypoint pixel neighborhoods, the more likely the respective keypoints are to match. As such, keypoint matching can be done based on the vector distances between the vectors of the pixel neighborhoods of unique copy keypoints and the pixel neighborhoods of the artifact.

In an aspect, a rigid transformation can be applied to restrict the matching of the unique copy keypoints to the artifact keypoints in a manner that limits the orientation of the artifact relative to the unique copy. The rigid transformation restricts the matching of the keypoints along certain rotations, translations, reflections, or any sequence of these, of the artifact. This can help limit the number of false alignments between the artifact and the unique copies. In essence, the rigid transformation restricts the size and shape of the geometry of the artifact relative to the unique copy when matching the keypoints. A least squares analysis can be used as part of the rigid transformation to properly orient the artifact relative to the unique copy. For instance, the rigid transformation can restrict the artifact to the same two-dimensional plane of the unique copy, aligning both on the same x-y coordinate plane, effectively aligning the artifact so that it has substantially the same perspective as the unique copy to which it will be compared. Since the matches may contain outliers or false positives, a robust linear system of equations is solved to find matches that are consistent with a rigid geometric alignment. To separate false positives and outliers, local optimization (LO) step is applied to gather a set of high-confidence inliers, which align with the unique copy in a consistent way. At each step of the optimization, the determinant of the least squares solution is constrained to ensure a rectangular final alignment. This can be used to restrict the artifact from having a certain determinant to align it with the x-y plane of the unique copy. To do this in the document space, the projective transformation restricts the matrices for rotation, translation, and scale. The alignment of the artifact to the unique copy can be scored using an R² measure, for example.

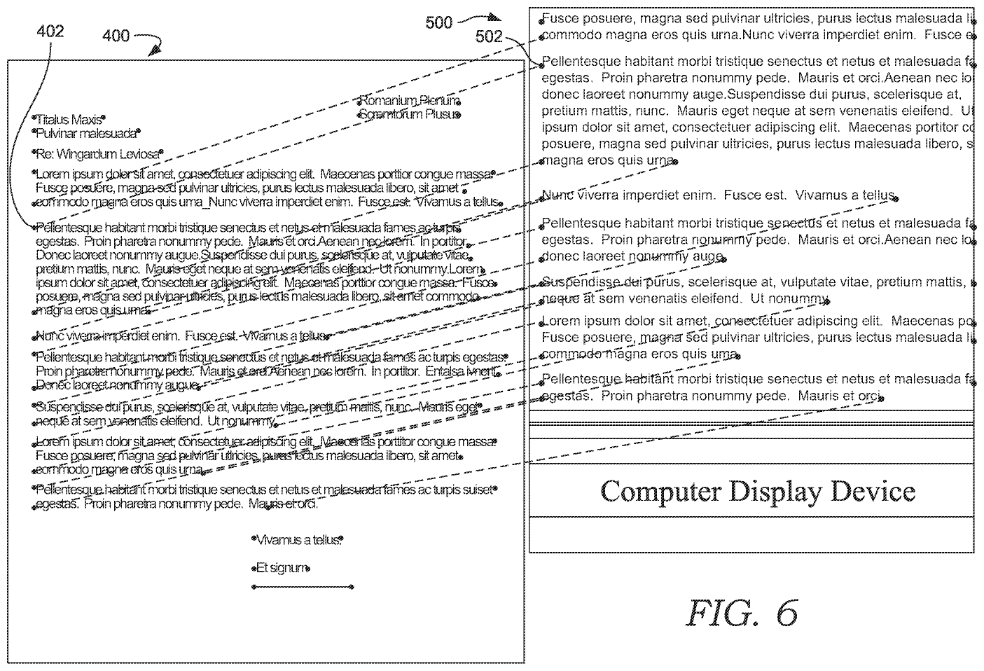

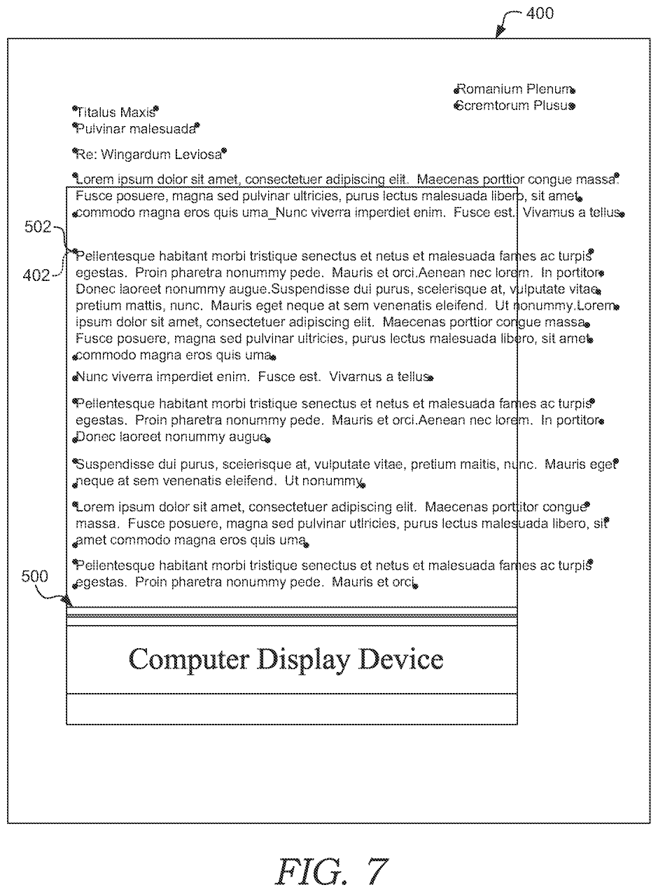

FIG. 6 is an example illustration of keypoint matcher 118 matching unique copy keypoints of unique copy 400 to artifact keypoints of artifact 500. One particular example shows unique copy keypoint 402 matching with artifact keypoint 502. Based on the matching, artifact 500 is effectively aligned with unique copy 400 along the same plane. At the same time, this aids in identifying the location from which artifact 500 was derived from unique copy 400. This is illustrated in FIG. 7, illustrating an overlay of artifact 500 of FIG. 5A and FIG. 5B with the unique copy 400 of FIG. 4A and FIG. 4B based on the matching shown in FIG. 6. In this example overlay, artifact keypoints, such as artifact keypoint 502, have been aligned with unique copy keypoints, such as unique copy keypoint 402.

As noted, the matching helps identify the location of a unique copy from which an artifact was derived. In doing so, relatively smaller fragments can be used to identify a unique copy as compared to previously described conventional methods. This is because of the high degree of accuracy the alignment provides. The alignment allows the unique copy to be identified with a higher degree of accuracy relative to the conventional methods described that don't include such an alignment process when comparing documents, as the alignment process aids in matching the unique copy keypoints to artifact keypoints by, for example, restricting unrealistic contortions of the artifact and unique copy that might find a better match mathematically, although that match may be unrealistic in the real world. Further, the alignment helps adjust for sizing that may occur when an artifact is derived. This is an improvement over conventional methods that do not adjust for sizing issues, leading to false positive or false negative document matches due to the size distortions. As such, high confidence levels in matching keypoints can be achieved, providing for more accurate and reliable unique copy identification for those decision-making systems or functions that rely on keypoint matching to determine that an artifact was derived from a unique copy with confidence, such as absolute match significance determiner 120 and unique match significance determiner 122, as will be further described.

Some additional keypoint matching methods are described in U.S. patent application Ser. No. 18/179,635, filed on Mar. 7, 2023, entitled “Information Source Detection Using Unique Watermarks,” which is hereby expressly incorporated by reference in its entirety.

Turning back to FIG. 3, having identified and matched the unique copy keypoints and artifact keypoints at block 302, the example process 300 determines an absolute match fraction at block 304. Absolute match significance determiner 120 of FIG. 1 can be used to determine the absolute match fraction. The absolute match fraction may be determined for each individual unique copy of the set of unique copies.

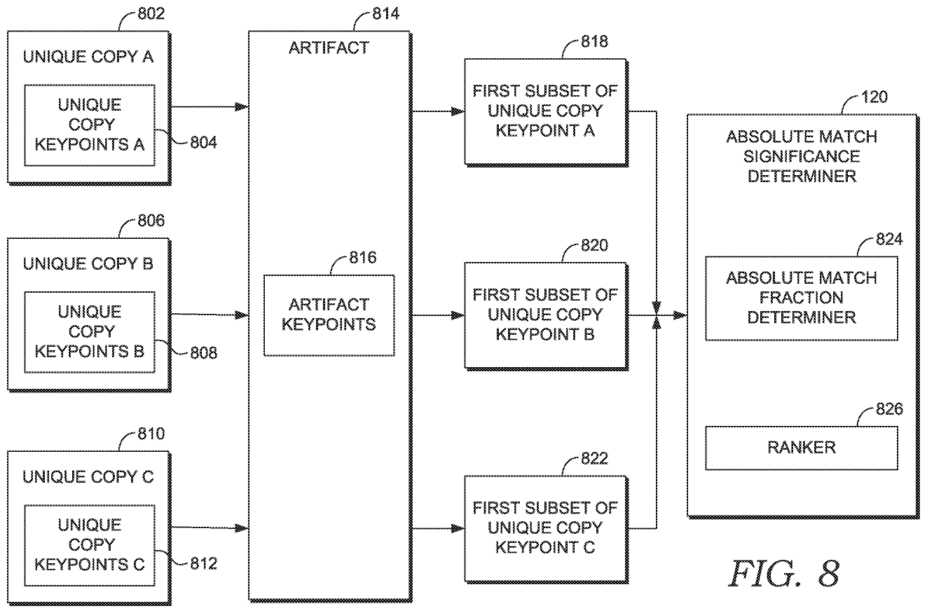

FIG. 8 provides an example illustration using absolute match significance determiner 120 in a manner to determine the absolute match fraction for each of a set of unique copies, which illustratively includes unique copy A 802, unique copy B 806, and unique copy C 810. While a set of three unique copies is provided, it will be understood that a set of unique copies may comprise any number of a plurality of unique copies.

As illustrated, each of the unique copies in the set of unique copies comprises respective keypoints. For instance, unique copy A 802 comprises unique copy keypoints A 804, unique copy B 806 comprises unique copy keypoints B 808, and unique copy C 810 comprises unique copy keypoints C 812. The unique copy keypoints for each respective unique copy may be determined and matched, as previously described by components of keypoint alignment and matching engine 114.

In determining the absolute match fraction, absolute match significance determiner 120 may employ absolute match fraction determiner 824. In an embodiment, an absolute match fraction compares the relative number of matching keypoints to the total number of keypoints for each of the unique copies. As an example, for an individual unique copy, the number of unique copy keypoints that match artifact keypoints is determined. The unique copy keypoints that match artifact keypoints may be stored in a first subset of unique copy keypoints for each of the unique copies. The total number of unique copy keypoints for the individual unique copy is also determined. The absolute match fraction may be determined as a fraction of the unique copy keypoints in the first subset of unique copy keypoints matching the artifact keypoints to the total number of unique copy keypoints for the individual unique copy, e.g., the unique copy keypoints of the first subset of unique copy keypoints divided by the unique copy keypoints for the unique copy.

To illustrate using FIG. 8, unique copy keypoints A 804 for unique copy A 802 that match artifact keypoints 816 of artifact 814 are provided as a first subset of unique copy keypoints A 818. Likewise, unique copy keypoints B 808 matching artifact keypoints 816 are provided as a first subset of unique copy keypoints B 820, while unique copy keypoints C 812 matching artifact keypoints 816 are provided to a first subset of unique copy keypoints C 822. Each first subset of unique copy keypoints for each of the unique copies can be provided to absolute match significance determiner 120 employing absolute match fraction determiner 824 for determining the absolute match fraction.

Turning back to FIG. 3, unique copies can be ranked using the absolute match fraction at block 306. Absolute match significance determiner 120 may further be used to rank the unique copies of a set based on the absolute match fraction for each unique copy.

As illustrated in FIG. 8, absolute match significance determiner 120 may employ ranker 826 to rank the unique copies. As noted, the absolute match fraction may be determined as a fraction of unique copy keypoints matching the artifact keypoints to the total number of unique copy keypoints for the individual unique copy. Thus, in an embodiment, those unique copies having a greater number of unique copy keypoints that match the artifact relative to other unique copies will have a greater value for the absolute match fraction. Ranker 826 can rank the unique copies such that a first-ranked unique copy has the greatest absolute match fraction, a second-ranked unique copy has the second greatest absolute match fraction of the set of unique copies, and so forth.

Continuing with FIG. 3, at decision block 308 a determination is made whether the absolute match fraction for the first-ranked unique copy is statistically significant. Absolute match significance determiner 120 may determine whether the absolute match fraction of the first-ranked unique copy is significant. Absolute match significance determiner 120 may determine whether the absolute match fraction of the first-ranked unique copy is significant based on an absolute match significance. The absolute match significance can be compared to a threshold value, and a decision made whether the absolute match fraction of the first-ranked unique copy is significant based on the absolute match significance compared to the threshold value. The threshold value may be set based on desired confidence levels. In an aspect, the absolute match significance may be a measure of the statistical significance between the absolute match fractions for each of the first-ranked unique copy and a second-ranked unique copy.

To provide an example, a p-value may be used to quantify significant differences between populations. Generally, a p-value is the probability of obtaining a result equal to or more extreme than what was actually observed under a null hypothesis (no difference other than natural variation between the populations). The probability of an alternative unique copy to the first-ranked unique copy in the set of unique copies actually matches an artifact is a p-value measurement between the first-ranked unique copy and the second-ranked unique copy—namely, how likely it is that the score gap is attributable to random chance.

In an aspect, a Pearson correlation coefficient may be used to determine the absolute match significance, e.g., the probability that an artifact matches another unique copy in the set. To determine the p-value, the following formula may be used to calculate a t-statistic. Here, r is the difference in the absolute match fractions between the first-ranked unique copy and the second-ranked unique copy, and n is the number of artifact keypoints in the artifact.

$$t = \frac{r \sqrt{n - 2}}{\sqrt{1 - {r}^{2}}}$$

The output of the formula is a t-statistic that can be turned into a probability using a t-distribution table, as is available in many statistical software tools. This probability is multiplied by N (the total number of unique copies in the set of unique copies) to get a final probability, i.e., the absolute match significance, according to this example.

With reference again to FIG. 3, as noted, the absolute match significance may be compared to a predetermined threshold to determine whether the probability is confidently high enough to identify the first-ranked unique copy as the unique copy from which the artifact was derived. If no, then according to the example in FIG. 3, the process 300 continues to block 314, where it stops. In this event, process 300 may not match a unique copy to the artifact. However, if yes, then the process proceeds to block 310 to determine a unique match fraction and then to decision block 312 to determine whether the unique match fraction of the first-ranked unique copy is significant.

Unique match significance determiner 122 may be employed to determine the unique match fraction and whether the unique match fraction is statistically significant. Unique match significance determiner 122 may determine a unique match fraction for each of the unique copies in the set of unique copies. The unique match fraction may be determined for each of the unique copies based on uniquely matching keypoints in each individual unique copy. Unique copy keypoints and their respective matching artifact keypoints may be identified from the matches determined using keypoint alignment and matching engine 114 employing keypoint matcher 118. The identified uniquely matching keypoints for each unique copy can be included in a second subset of unique copy keypoints of each unique copy.

As an example, uniquely matching keypoints may comprise unique copy keypoints that match the artifact keypoints in only one of the unique copies in the set of unique copies. That is, for an individual unique copy, the uniquely matching keypoints may include those unique copy keypoints that match artifact keypoints, where the respective matching artifact keypoints do not match other unique copy keypoints of other unique copies in the set of unique copies. Put another way, uniquely matching keypoints may refer to unique copy keypoints for an individual unique copy that matches artifact keypoints within an artifact that match exclusively to the unique copy keypoints in that individual unique copy.

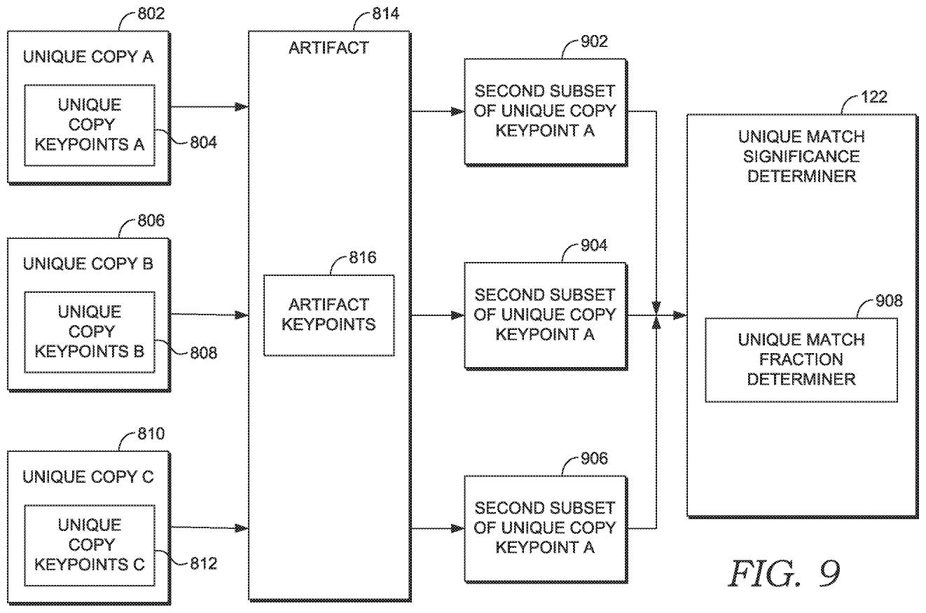

Having determined the uniquely matching keypoints for each of the unique copies in the set of unique copies, unique match significance determiner 122 can determine a unique match fraction for the unique copies. Briefly referring to the example illustrated in FIG. 9, in an embodiment, unique match significance determiner 122 employs unique match fraction determiner 908 to determine the unique match fraction. As will be described, the unique match significance may be based on the unique match fraction.

In an aspect, the unique match fraction is determined as a fraction of the uniquely matching keypoints for an individual unique copy to a total number of unique copy keypoints identified in the individual unique copy. For instance, unique match fraction determiner 908 may identify the determined uniquely matching keypoints for an individual unique copy and divide a number of the uniquely matching keypoints by the total number of unique copy keypoints identified in the individual unique copy to determine the unique match fraction. This may be done for any or all of the unique copies in the set of unique copies. In an aspect, the unique match fraction is determined for at least the first-ranked unique copy and the second-ranked unique copy.

Using FIG. 9 to illustrate an example, the figure includes the set of unique copies that comprises unique copy A 802, unique copy B 806, and unique copy keypoints B 808. Each of the unique copies respectively includes unique copy keypoints A 804, unique copy keypoints B 808, and unique copy keypoints C 812, as determined using keypoint alignment and matching engine 114 employing keypoint identifier 116. Artifact 814 comprises artifact keypoints 816, as determined using keypoint identifier 116. Matches between unique copy keypoints A 804, unique copy keypoints B 808, and unique copy keypoints C 812 and the artifact keypoints 816 are determined using keypoint matcher 118. The unique copy keypoints within unique copy keypoints A 804 that match artifact keypoints within artifact keypoints 816, where the matching artifact keypoints do not match other unique copy keypoints of other unique copies, such as unique copy B 806 and unique copy C 810, are included within a second subset of unique copy keypoints A 902. The unique copy keypoints within unique copy keypoints B 808 that match artifact keypoints within artifact keypoints 816, where the matching artifact keypoints do not match other unique copy keypoints of other unique copies, such as unique copy A 802 and unique copy C 810, are included within a second subset of unique copy keypoints B 904. The unique copy keypoints within unique copy keypoints C 812 that match artifact keypoints within artifact keypoints 816, where the matching artifact keypoints do not match other unique copy keypoints of other unique copies, such as unique copy A 802 and unique copy B 806, are included within a second subset of unique copy keypoints C 906. As such, each of the second subset of unique copy keypoints A 902, the second subset of unique copy keypoints B 904, and the second subset of unique copy keypoints C 906 comprises the uniquely matching keypoints for the respective unique copy A 802, unique copy keypoints A 804, and unique copy B 806.

Continuing with the example in FIG. 9, unique match fraction determiner 908 may determine the unique match fraction for the unique copy A 802, unique copy B 806, and unique copy C 810. The unique match fraction for unique copy A 802 may be the number of unique copy keypoints in the second subset of unique copy keypoints A 902 relative to the total number of unique copy keypoints A 804. Likewise, the unique match fraction for unique copy B 806 may be the number of unique copy keypoints in the second subset of unique copy keypoints B 904 relative to the total number of unique copy keypoints B 808, while the unique match fraction for unique copy C 810 may be the number of unique copy keypoints in the second subset of unique copy keypoints C 906 relative to the total number of unique copy keypoints C 812.

Having determined the unique match fraction for unique copies of the set of unique copies, unique match significance determiner 122 may determine whether the unique match fraction for the first-ranked unique copy is significant, i.e., may determine the unique match significance. In an embodiment, the unique match significance measures the probability that the artifact might be derived from a copy not included in the set of unique copies. This helps prevent erroneously matching a unique copy to an artifact from a set of unique copies that does not include the true copy from which the artifact was derived, which is an advancement of the selection processes of conventional methods, as previously described. In essence, the unique match significance determined from the unique match fraction helps avoid the scenario of selecting the best of all bad options.

As an example, the unique match significance can be determined using a correlation, such as a Pearson correlation coefficient. The following can again be used to calculate the t-statistic:

$$t = \frac{r \sqrt{n - 2}}{\sqrt{1 - {r}^{2}}} ,$$

where r is the difference between the unique match fraction of the first-ranked unique copy and the unique match fraction of the second-ranked unique copy, and n is the number of artifact keypoints in the artifact. The output of the formula is a t-statistic that can be turned into a probability using a t-distribution table. The probability is multiplied by N to get a final probability, i.e., the unique match significance, where N is the total number of unique copies in the set. The unique match significance can be compared to a threshold value, and a decision made whether the unique match significance of the first-ranked unique copy is significant based on the comparison to the threshold value. The threshold value may be set based on desired confidence levels.

Referring back to FIG. 3, the unique match significance may be compared to a predetermined threshold to determine whether the probability is confidently high enough to identify the first-ranked unique copy as the unique copy from which the artifact was derived. If no, then according to the example in FIG. 3, the process 300 continues to block 314, where it stops. In this event, process 300 may not match a unique copy to the artifact. However, if yes, then the process proceeds to block 316 where it is determined that the first-ranked unique copy matches the artifact. As noted, there is a high confidence that the artifact matches the first-ranked unique copy.

In an aspect, a determination is made by detector 112 that the first-ranked unique copy matches the artifact based on a combination of the absolute match significance and the unique match significance values. That is, these values can be added together to derive an overall probability that the unique copy matches the artifact. This overall probability can be used as the basis of a decision on whether to output an indication that the unique copy matches the artifact by comparing it to a threshold probability. The threshold probability value may be empirically determined by offline simulations, and set based on a desired level of confidence.

Based on determining that the unique copy matches the artifact based on the absolute match significance and the unique match significance, the identified unique copy may be output as the unique copy from which the artifact was derived.

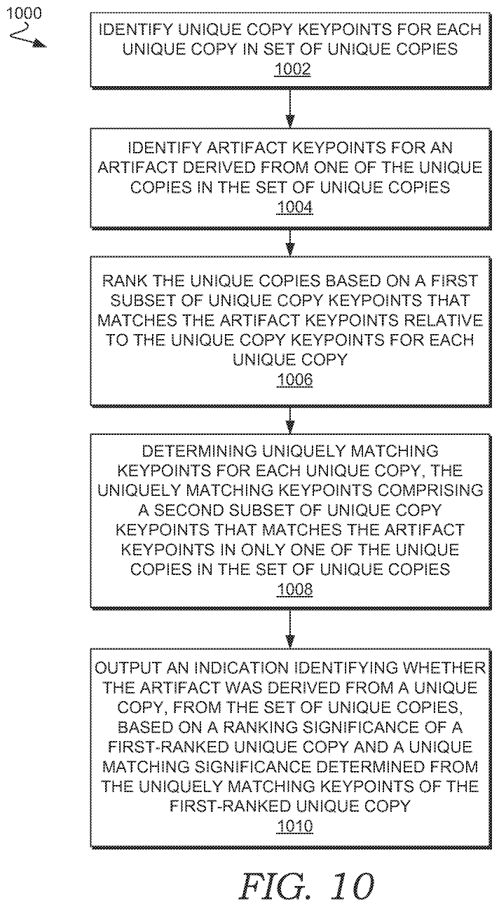

Referring now to FIG. 10, a flow diagram is provided with an example method 1000 for identifying and providing a unique copy from which an artifact was derived. Each block of method 1000 may comprise a computing process performed using any combination of hardware, firmware, or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), or a plug-in to another product, to name a few possibilities. Method 1000 may be implemented in whole or in part by components of operating environment 100.

At block 1002, unique copy keypoints are identified for each unique copy in a set of unique copies. The set of unique copies may be unique copies of an original document having one or more perturbations made that distinguishes the unique copies. The unique copies may have been generated by encoder 110. Unique copy keypoints may be identified in each of the unique copies using keypoint alignment and matching engine 114 employing keypoint identifier 116.

At block 1004, artifact keypoints for an artifact are identified. The artifact is derived from one of the unique copies in the set of unique copies. Artifact keypoints may be identified by keypoint alignment and matching engine 114 employing keypoint identifier 116.

In an aspect, the method includes matching unique copy keypoints for each of the unique copies to the artifact keypoints. This may be done by keypoint alignment and matching engine 114 employing keypoint matcher 118. In an aspect, the keypoints may be stored and accessed for identifying a unique copy from which the artifact was derived.

At block 1006, the unique copies may be ranked based on unique copy keypoints matching the artifact keypoints. The unique copy keypoints or the artifact keypoints may be identified or otherwise accessed to perform the ranking. In an aspect of the technology, the ranking may be performed by ranker 826. To rank the unique copies, a first subset of unique copy keypoints may be determined for each of the unique copies. The first subset may include unique copy keypoints that match artifact keypoints. The ranking may provide at least a first-ranked unique copy and a second-ranked unique copy.

In an aspect, the ranking is based on an absolute match fraction. The absolute match fraction may be a fraction determined for each of the unique copies as a fraction of unique copy keypoints included in the first subset of unique copy keypoints for an individual unique copy to a total number of unique copy keypoints identified in the individual unique copy. The absolute match fraction may be determined by absolute match fraction determiner 824 of absolute match significance determiner 120.

At block 1008, uniquely matching keypoints are determined for each unique copy. The uniquely matching keypoints may include unique copy keypoints that match artifact keypoints, where the matching artifact keypoints do not match unique copy keypoints of the other unique copies in the set of unique copies. The determined uniquely matching keypoints may be included in a second subset of unique copy keypoints for each unique copy. That is, the uniquely matching keypoints within a second subset of unique copy keypoints are unique copy keypoints that match the artifact keypoints for only one of the unique copies in the set of unique copies. Keypoint matching may be performed using keypoint alignment and matching engine 114 employing keypoint matcher 118 to determine the uniquely matching keypoints.

In an aspect, the uniquely matching keypoints are determined for at least the first-ranked unique copy and the second-ranked unique copy. That is, a second subset of unique copy keypoints including the uniquely matching keypoints for each of at least the first-ranked unique copy and the second-ranked unique copy may be determined.

At block 1010, an indication is output that identifies whether the artifact was derived from a unique copy from the set of unique copies. In an aspect, the unique copy from which the artifact was derived is output. The identification of the matching unique copy, the copy from which the artifact was derived, may be based on an absolute match significance and a unique match significance. In an aspect, the matching unique copy is identified based on the matching unique copy being a first-ranked unique copy, as well as the absolute match significance and the unique match significance of the first-ranked unique copy.

In an aspect, the absolute match significance is determined using absolute match significance determiner 120. The absolute match significance may be based on the absolute match fraction. As an example, the absolute match significance is a measure of statistical significance between the absolute match fraction for each of the first-ranked unique copy and a second-ranked unique copy.

In an aspect, the unique match significance is determined using unique match significance determiner 122. The unique match significance may be based on the unique match fraction. As an example, the unique match significance is a measure of statistical significance of the unique match fraction for the first-ranked unique copy relative to the unique match fractions of other ranked unique copies, such as the second-ranked unique copy.

In an aspect, an overall probability that the unique copy matches the artifact is determined from a combination of the absolute match significance and the unique match significance. The overall probability may be compared to a threshold probability to determine whether to output an indication that the unique copy matches the artifact. The threshold probability may be an empirically determined threshold.

Having described an overview of some embodiments of the present technology, an example computing environment in which embodiments of the present technology may be implemented is described below in order to provide a general context for various aspects of the present technology. Referring now to FIG. 11 in particular, an example operating environment for implementing embodiments of the present technology is shown and designated generally as computing device 1100. Computing device 1100 is but one example of a suitable computing environment and is not intended to suggest any limitation as to the scope of use or functionality of the technology. Computing device 1100 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant, or other handheld device. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 11, computing device 1100 includes bus 1102, which directly or indirectly couples the following devices: memory 1104, one or more processors 1106, one or more presentation components 1108, input/output (I/O) ports 1110, input/output components 1112, and illustrative power supply 1114. Bus 1102 represents what may be one or more buses (such as an address bus, data bus, or combination thereof). Although the various blocks of FIG. 11 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 11 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 11 and with reference to “computing device.”

Computing device 1100 typically includes a variety of computer-readable media. Computer-readable media can be any available media that can be accessed by computing device 1100 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 1100. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 1104 includes computer-storage media in the form of volatile or non-volatile memory. The memory may be removable, non-removable, or a combination thereof. Example hardware devices include solid-state memory, hard drives, optical-disc drives, etc. Computing device 1100 includes one or more processors that read data from various entities, such as memory 1104 or I/O components 1112. Presentation component(s) 1108 presents data indications to a user or other device. Example presentation components include a display device, speaker, printing component, vibrating component, etc.

I/O ports 1110 allow computing device 1100 to be logically coupled to other devices, including I/O components 1112, some of which may be built in. Illustrative components include a microphone, joystick, game pad, satellite dish, scanner, printer, wireless device, etc. The I/O components 1112 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 1100. Computing device 1100 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 1100 may be equipped with accelerometers or gyroscopes that enable detection of motion. The output of the accelerometers or gyroscopes may be provided to the display of computing device 1100 to render immersive augmented reality or virtual reality.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. In this regard, components for determining a unique copy from which an artifact was derived can manage resources and provide the described functionality. Any other variations and combinations thereof are contemplated within embodiments of the present technology.

With reference briefly back to FIG. 1, it is noted and again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1, such as those described in relation to 112, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as database 106. Moreover, functions of 112, among other functions, may be performed by server 102, computing device 104, or any other component, in any combination.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

Some example aspects that can be practiced from the forgoing description include the following:

Aspect 1: A system comprising: at least one processor; and one or more computer storage media storing computer-readable instructions thereon that when executed by the at least one processor cause the at least one processor to perform operations comprising: identifying unique copy keypoints for each unique copy in a set of unique copies; identifying artifact keypoints for an artifact derived from one of the unique copies in the set of unique copies; ranking the unique copies based on a first subset of unique copy keypoints that matches the artifact keypoints relative to the unique copy keypoints for each unique copy; determining uniquely matching keypoints for each unique copy, the uniquely matching keypoints comprising a second subset of unique copy keypoints that matches the artifact keypoints for only one of the unique copies in the set of unique copies; and from the set of unique copies, providing a unique copy from which the artifact was derived based on an absolute match significance of a first-ranked unique copy and a unique match significance determined from the uniquely matching keypoints of the first-ranked unique copy.

Aspect 2: A method performed by one or more processors, the method comprising: ranking unique copies of a set of unique copies based on a first subset of unique copy keypoints that matches artifact keypoints of an artifact relative to unique copy keypoints within each unique copy; determining uniquely matching keypoints for each unique copy, the uniquely matching keypoints comprising a second subset of unique copy keypoints that matches the artifact keypoints for only one of the unique copies in the set of unique copies; and from the set of unique copies, providing a unique copy from which the artifact was derived based on an absolute match significance of a first-ranked unique copy and a unique match significance determined from the uniquely matching keypoints of the first-ranked unique copy.

Aspect 3: One or more computer storage media storing computer-readable instructions thereon that, when executed by a processor, cause the processor to perform a method comprising: identifying unique copy keypoints for each unique copy in a set of unique copies; identifying artifact keypoints for an artifact derived from one of the unique copies in the set of unique copies; ranking the unique copies based on a first subset of unique copy keypoints that matches the artifact keypoints relative to the unique copy keypoints for each unique copy; determining uniquely matching keypoints for each unique copy, the uniquely matching keypoints comprising a second subset of unique copy keypoints that matches the artifact keypoints for only one of the unique copies in the set of unique copies; and outputting an indication identifying whether the artifact was derived from a unique copy, from the set of unique copies, based on an absolute match significance of a first-ranked unique copy and a unique match significance determined from the uniquely matching keypoints of the first-ranked unique copy.

Aspect 4: Any of Aspects 1-3, wherein, for each unique copy, the first subset of unique copy keypoints is determined by selecting unique copy keypoints from an individual unique copy based on the selected unique copy keypoints matching a corresponding artifact keypoint in the artifact.

Aspect 5: Any of Aspects 1-4, further comprising determining an absolute match fraction for each of the unique copies in the set of unique copies, the absolute match fraction determined as a fraction of unique copy keypoints included in the first subset of unique copy keypoints for an individual unique copy to a total number of unique copy keypoints identified in the individual unique copy, wherein the first subset of unique copy keypoints is relative to the unique copy keypoints based on the absolute match fraction.

Aspect 6: Aspect 5, wherein the absolute match significance is a measure of statistical significance between the absolute match fraction for each of the first-ranked unique copy and a second-ranked unique copy.

Aspect 7: Any of Aspects 1-6, wherein the second subset of unique copy keypoints for an individual unique copy comprises the unique copy keypoints selected from the individual unique copy that matches artifact keypoints, and wherein the matching artifact keypoints for the individual unique copy do not match other unique copy keypoints of other unique copies in the set of unique copies.

Aspect 8: Any of Aspects 1-7, further comprising determining a unique match fraction for each of the unique copies, the unique match fraction determined as a fraction of the uniquely matching keypoints included in the second subset of unique copy keypoints for an individual unique copy to a total number of unique copy keypoints identified in the individual unique copy, wherein the unique match significance is based on the unique match fraction for the provided unique copy.

Aspect 9: Aspect 8, wherein the unique match significance is a measure of statistical significance of the unique match fraction for the first-ranked unique copy relative to the unique match fractions of other ranked unique copies.

What is claimed is:

1. A system comprising:
at least one processor; and
one or more computer storage media storing computer-readable instructions thereon that when executed by the at least one processor cause the at least one processor to perform operations comprising:
identifying unique copy keypoints for each unique copy in a set of unique copies;
identifying artifact keypoints for an artifact derived from one of the unique copies in the set of unique copies;
ranking the unique copies based on a first subset of unique copy keypoints that matches the artifact keypoints relative to the unique copy keypoints for each unique copy;
determining uniquely matching keypoints for each unique copy, the uniquely matching keypoints comprising a second subset of unique copy keypoints that matches the artifact keypoints for only one of the unique copies in the set of unique copies; and
from the set of unique copies, providing a unique copy from which the artifact was derived based on an absolute match significance of a first-ranked unique copy and a unique match significance determined from the uniquely matching keypoints of the first-ranked unique copy.

2. The system of claim 1, wherein, for each unique copy, the first subset of unique copy keypoints is determined by selecting unique copy keypoints from an individual unique copy based on the selected unique copy keypoints matching a corresponding artifact keypoint in the artifact.

3. The system of claim 1, further comprising determining an absolute match fraction for each of the unique copies in the set of unique copies, the absolute match fraction determined as a fraction of unique copy keypoints included in the first subset of unique copy keypoints for an individual unique copy to a total number of unique copy keypoints identified in the individual unique copy, wherein the first subset of unique copy keypoints is relative to the unique copy keypoints based on the absolute match fraction.

4. The system of claim 3, wherein the absolute match significance is a measure of statistical significance between the absolute match fraction for each of the first-ranked unique copy and a second-ranked unique copy.

5. The system of claim 1, wherein the second subset of unique copy keypoints for an individual unique copy comprises the unique copy keypoints selected from the individual unique copy that match artifact keypoints, and wherein the matching artifact keypoints for the individual unique copy do not match other unique copy keypoints of other unique copies in the set of unique copies.

6. The system of claim 1, further comprising determining a unique match fraction for each of the unique copies, the unique match fraction determined as a fraction of the uniquely matching keypoints included in the second subset of unique copy keypoints for an individual unique copy to a total number of unique copy keypoints identified in the individual unique copy, wherein the unique match significance is based on the unique match fraction for the provided unique copy.

7. The system of claim 6, wherein the unique match significance is a measure of statistical significance of the unique match fraction for the first-ranked unique copy relative to the unique match fractions of other ranked unique copies.

8. A method performed by one or more processors, the method comprising:
ranking unique copies of a set of unique copies based on a first subset of unique copy keypoints that matches artifact keypoints of an artifact relative to unique copy keypoints within each unique copy;
determining uniquely matching keypoints for each unique copy, the uniquely matching keypoints comprising a second subset of unique copy keypoints that matches the artifact keypoints for only one of the unique copies in the set of unique copies; and
from the set of unique copies, providing a unique copy from which the artifact was derived based on an absolute match significance of a first-ranked unique copy and a unique match significance determined from the uniquely matching keypoints of the first-ranked unique copy.

9. The method of claim 8, further comprising determining a first subset of unique copy keypoints for each unique copy by selecting unique copy keypoints from an individual unique copy based on the unique copy keypoints matching a corresponding artifact keypoint in the artifact.

10. The method of claim 8, further comprising determining an absolute match fraction for each of the unique copies in the set of unique copies, the absolute match fraction determined as a fraction of unique copy keypoints included in the first subset of unique copy keypoints for an individual unique copy to a total number of unique copy keypoints identified in the individual unique copy, wherein the first subset of unique copy keypoints is relative to the unique copy keypoints based on the absolute match fraction.

11. The method of claim 10, wherein the absolute match significance is a measure of statistical significance between the absolute match fraction for each of the first-ranked unique copy and a second-ranked unique copy.

12. The method of claim 8, wherein the second subset of unique copy keypoints for an individual unique copy comprises the uniquely matching keypoints selected from the individual unique copy that match the artifact keypoints, and wherein the matching artifact keypoints for the individual unique copy do not match other unique copy keypoints of other unique copies in the set of unique copies.

13. The method of claim 8, further comprising determining a unique match fraction for each of the unique copies, the unique match fraction determined as a fraction of unique copy keypoints included in the second subset of unique copy keypoints for an individual unique copy to a total number of unique copy keypoints identified in the individual unique copy, wherein the unique match significance is based on the unique match fraction for the provided unique copy.

14. The method of claim 13, wherein the unique match significance is a measure of statistical significance of the unique match fraction for the first-ranked unique copy relative to the unique match fractions of other ranked unique copies.

15. One or more computer storage media storing computer-readable instructions thereon that, when executed by a processor, cause the processor to perform a method comprising:
identifying unique copy keypoints for each unique copy in a set of unique copies;
identifying artifact keypoints for an artifact derived from one of the unique copies in the set of unique copies;
ranking the unique copies based on a first subset of unique copy keypoints that matches the artifact keypoints relative to the unique copy keypoints for each unique copy;
determining uniquely matching keypoints for each unique copy, the uniquely matching keypoints comprising a second subset of unique copy keypoints that matches the artifact keypoints for only one of the unique copies in the set of unique copies; and
outputting an indication identifying whether the artifact was derived from a unique copy, from the set of unique copies, based on an absolute match significance of a first-ranked unique copy and a unique match significance determined from the uniquely matching keypoints of the first-ranked unique copy.

16. The media of claim 15, further comprising determining a first subset of unique copy keypoints for each unique copy by selecting unique copy keypoints from an individual unique copy based on the unique copy keypoints matching a corresponding artifact keypoint in the artifact.

17. The media of claim 15, further comprising determining an absolute match fraction for each of the unique copies in the set of unique copies, the absolute match fraction determined as a fraction of unique copy keypoints included in the first subset of unique copy keypoints for an individual unique copy to a total number of unique copy keypoints identified in the individual unique copy, wherein the first subset of unique copy keypoints is relative to the unique copy keypoints based on the absolute match fraction.

18. The media of claim 17, wherein the absolute match significance is a measure of statistical significance between the absolute match fraction for each of the first-ranked unique copy and a second-ranked unique copy.

19. The media of claim 15, further comprising determining a unique match fraction for each of the unique copies, the unique match fraction determined as a fraction of the uniquely matching keypoints included in the second subset of unique copy keypoints for an individual unique copy to a total number of unique copy keypoints identified in the individual unique copy, wherein the unique match significance is based on the unique match fraction for the provided unique copy.

20. The media of claim 19, wherein the unique match significance is a measure of statistical significance of the unique match fraction for the first-ranked unique copy relative to the unique match fractions of other ranked unique copies.
